(19) United States
(12) Patent Application Publication
(10) Pub. No.: US 2019/0322085 A1
(43) Pub. Date: Oct. 24, 2019

(54) Floating Tile

(71) Applicant: Shahriar Eftekharzadeh, Torrance, CA (US)

(72) Inventor: Shahriar Eftekharzadeh, Torrance, CA (US)

(21) Appl. No.: 16/456,609

(22) Filed: Jun. 28, 2019

(51) Int. Cl. B32B 27/06; B32B 27/32; B32B 5/18

(52) U.S. Cl. CPC B32B 27/065; B32B 27/32; B32B 5/18; B32B 2307/71; B32B 2266/0228; B32B 2255/20; B32B 2255/102; B32B 2307/718

(57) ABSTRACT

A floating tile for shielding open water surfaces from evaporation and external elements.

### FIELD OF THE INVENTION

The present invention pertains to floating covers for open water surfaces. In particular, the present invention provides a new floating tile for shielding open water surfaces from evaporation and external elements.

### BACKGROUND OF THE INVENTION

The need to cover over large open water surfaces arises from the necessity to prevent water loss through evaporation and to protect the water body from external elements causing pollution. Current solutions are various forms of floating covers comprised of flexible membranes with various means of providing buoyancy for floatation and restraints for the membrane. There are a number of issues with flexible floating membranes that include formation of surface puddles due to sagging and hence the need for drainage, inadequate long-term resistance to ultraviolet (UV) radiation and limited durability and life, chemical instability and leakage of pollutants from the membranes into the water body, difficulty of deployment and retrieval with high tensile strength requirement of the membrane to resist external loads, and cost. These issues have limited the utility of existing covers to small reservoirs leaving the covering of large open water surface areas impractical.

Therefore, there is a need for a cost effective, durable, UV-resistant, and practical floating cover for large open water surfaces that is not susceptible to sagging and formation of surface puddles and which easily can be deployed and retrieved without the need for high tensile strength materials and restraints.

### SUMMARY OF THE INVENTION

The present invention provides a solution for the above stated need with a floating tile comprised of a thin layer of protective material such as concrete at the surface, a layer of buoyant material directly below, and a two-compartment container made from non-biodegradable, chemically stable, and durable material such as plastic that provides housing for the protective and buoyant layers plus adequate submergence depth for stability. The covering of large open water surfaces is accomplished by deploying and closely packing together a plurality of freely floating individual tiles having unrestricted freedom of movement.

The preferred geometric shape of the present invention is a square. This is because of symmetry about both horizontal axes, and straight edges that can perfectly align side by side to accomplish full coverage when packed. However, there may be practical justifications to use other shapes such as rectangular, trapezoidal, triangular, and even circular.

The present invention is comprised of a two-compartment, open top and bottom plastic container with a relatively short compartment atop a taller compartment below with a horizontal partition in-between that serves as the floor of the upper compartment and the ceiling of the lower compartment. The upper compartment fits a layer of buoyant material atop its floor to provide the required buoyancy for the tile. The buoyant material can take a number of forms including expanded polystyrene (EPS), air filled cells, honey come membrane, second partition with air gap, etc., or the partition between the upper and lower compartments itself could be made buoyant thus eliminating the need for a separate buoyant layer. With the buoyant layer in place, the upper compartment leaves the exact depth above to house the required thickness of the protective material, which serves as the exposed surface of the tile providing protection against the elements, particularly UV radiation. One efficient way of forming the protective layer is casting by pouring wet concrete in the upper compartment filling the space above the buoyant layer, with surface either flush with the container top, or shaped as desired with a mold or a stamp.

The purpose of the lower compartment is to provide the tile with adequate submerged depth so adjacent tiles can afford large relative vertical movement without one tile piling on top of the other. This is one reason for the lower compartment being relatively tall compared with the upper compartment. There is at least one hole in the wall of the lower compartment just below the ceiling to vent out the trapped air inside when the tile is placed in water. The exhaust of the trapped air is necessary to enable the complete submergence of the lower compartment down to the ceiling and below, such that the buoyant layer in the upper compartment can serve its buoyancy function.

With the tile floating, the lower compartment is completely filled with water. The means that the effective weight of the tile also includes the weight of the water inside the lower compartment, which is several times larger than the combined weight of the materials that make up the tile. Any attempt at moving the tile laterally will also move the water inside the lower compartment and any effort at lifting the tile vertically will also lift the water inside until the hole(s) in the wall of the lower compartment is above the water level to allow entry of air and permit the slow draining of the lower compartment. This is a crucial feature of the present invention that gives the tile much added inertia and stability and provides it with resistance against external forces such as the wind and water currents.

The above-disclosed arrangement and features of the present invention addresses and resolves the major issues and shortcomings of the present art. The present invention provides a truly simple and cost-effective means of covering large areas of open water surfaces with concrete, which is a highly durable and tested material widely used for paving open surfaces with tremendous durability and success.

It is an object of the present invention to provide a cost effective, durable, UV-resistant, and practical floating cover for large open water surfaces that is not susceptible to sagging and formation of surface puddles.

It is an object of the present invention to provide improved elements and arrangements by apparatus for the purposes described thereof, which is comparable in cost with existing systems, dependable, and fully effective in accomplishing its intended purposes.

These and other objects of the present invention will become readily apparent upon further review of the following specification and drawings.

### BRIEF DESCRIPTION OF THE DRAWINGS

FIG. 1 is an expanded view of the preferred embodiment of the present invention looking from above showing a two-compartment container with air vent holes, a layer of buoyant material, and a layer of protective material on top.

FIG. 2 is an expanded view of the preferred embodiment of the present invention looking from below showing a two-compartment container with air vent holes, a layer of buoyant material, and a layer of protective material on top.

FIG. 3 is the same expanded view of the preferred embodiment of the present invention as in FIG. 1, but with layer of buoyant material placed in position inside the upper compartment of the two-compartment container.

FIG. 4 is the fully assembled floating tile of the preferred embodiment of the present invention looking from above with the protective layer placed in position over the buoyant layer, inside the upper compartment of the two-compartment container.

FIG. 5 is the fully assembled floating tile of the preferred embodiment of the present invention floating in water looking from above.

FIG. 6 is the fully assembled floating tile of the preferred embodiment of the present invention floating in water looking from below.

FIG. 7 is a plurality of the floating tiles of the preferred embodiment of the present invention packed together and floating in water.

### DETAILED DESCRIPTION

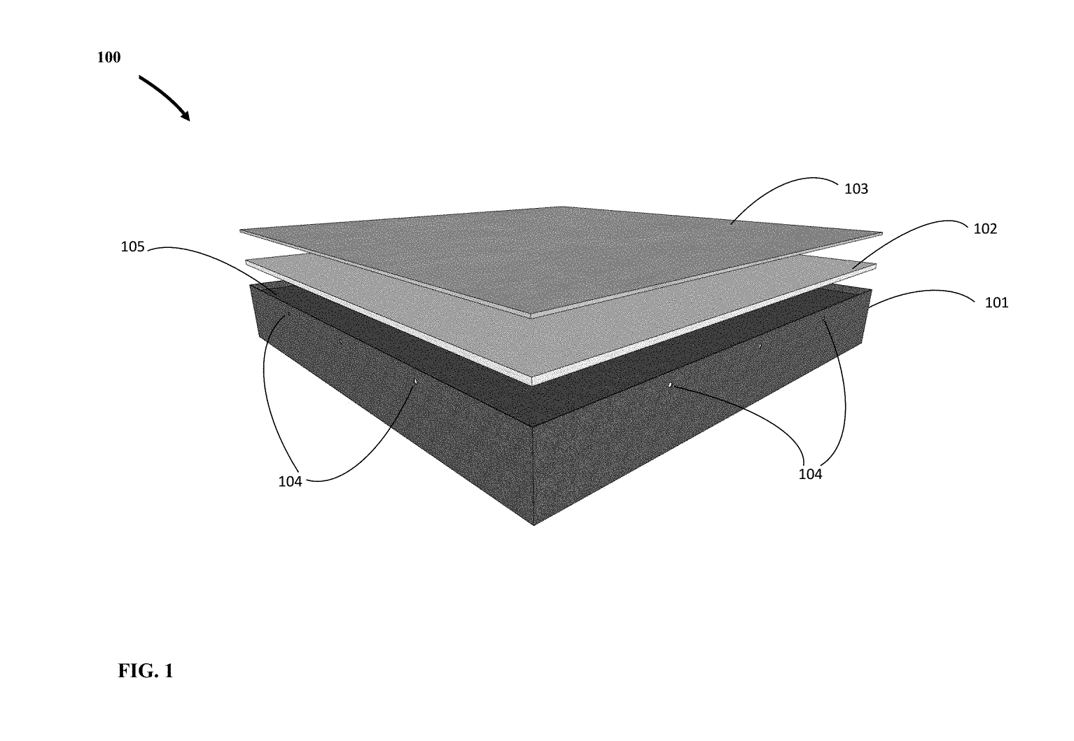

Referring to FIG. 1 there is shown an expanded view of the preferred embodiment of tile 100 looking from above showing the upper compartment of a two-compartment container 101 with air vent holes 104, a buoyant layer 102, and a layer of protective material such as concrete 103. Protective layer 103 serves as the main element of tile 100 for shielding against ultraviolet radiation (UV). Partition 105 is a flat layer of certain thickness that serves as floor of the upper compartment and ceiling of the lower compartment. The upper compartment is disposed to house buoyant layer 102 and protective layer 103. Container 101 is may be manufactured from thermoplastics such as polyethylene with additives such as carbon black for UV resistance. However, other materials could be used.

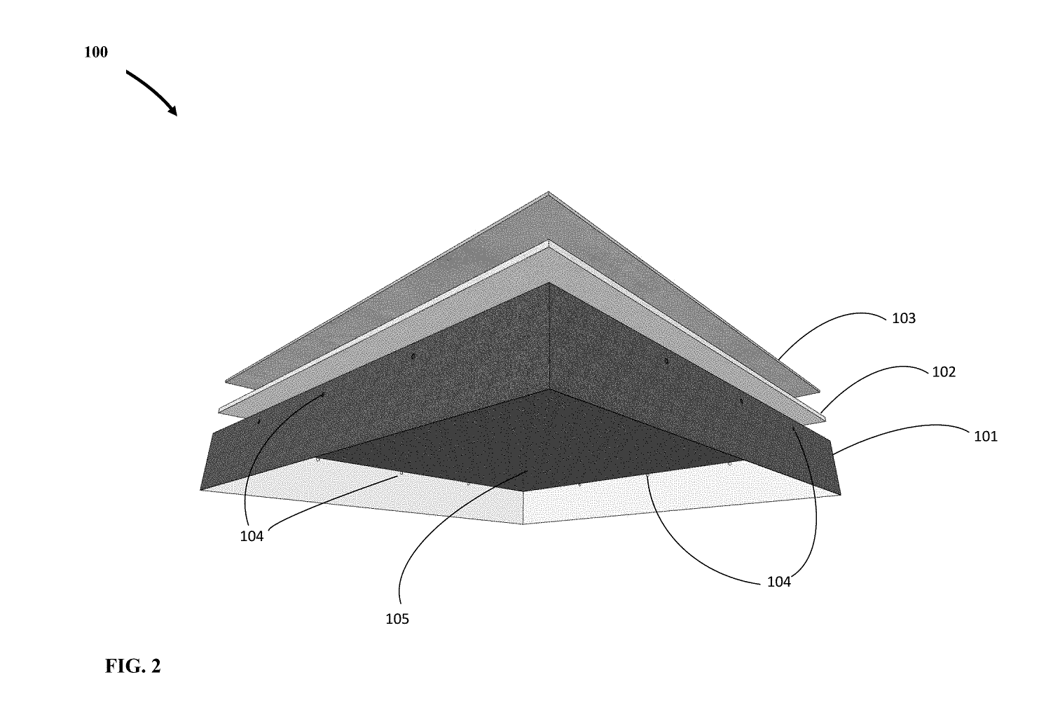

FIG. 2 shows an expanded view of the preferred embodiment tile 100 looking from below showing the lower compartment of a two-compartment container 101 with air vent holes 104, buoyant layer 102, protective layer 103. Partition 105 is a flat layer of certain thickness that serves as floor of the upper compartment and ceiling of the lower compartment. The lower compartment is disposed to provide tile 100 with adequate submerged depth so adjacent tiles can afford large relative vertical movement without piling. There are a plurality of equally spaced holes 104 immediately below partition 105 to vent out the trapped air inside lower compartment when tile 100 is placed in water.

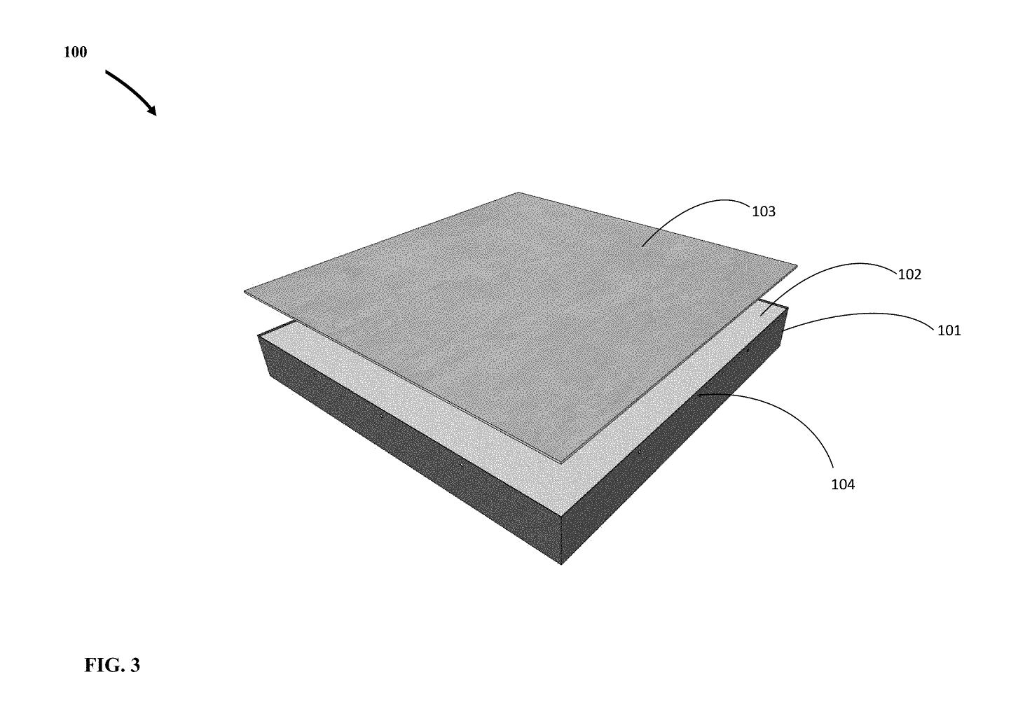

FIG. 3 shows the same expanded view of tile 100 as in FIG. 1, but with buoyant layer 102 placed in position inside the upper compartment of plastic container 101. Buoyant layer 102 is cut to exact dimensions to provide a tight fit inside the upper compartment of container 101. Buoyant layer 102 may be made from a variety of materials including expanded polystyrene, air filled cells, honey come membrane, or a second partition with air gap. One option is for partition 105 to be made intrinsically buoyant thus eliminating the need for a separate buoyant layer 102.

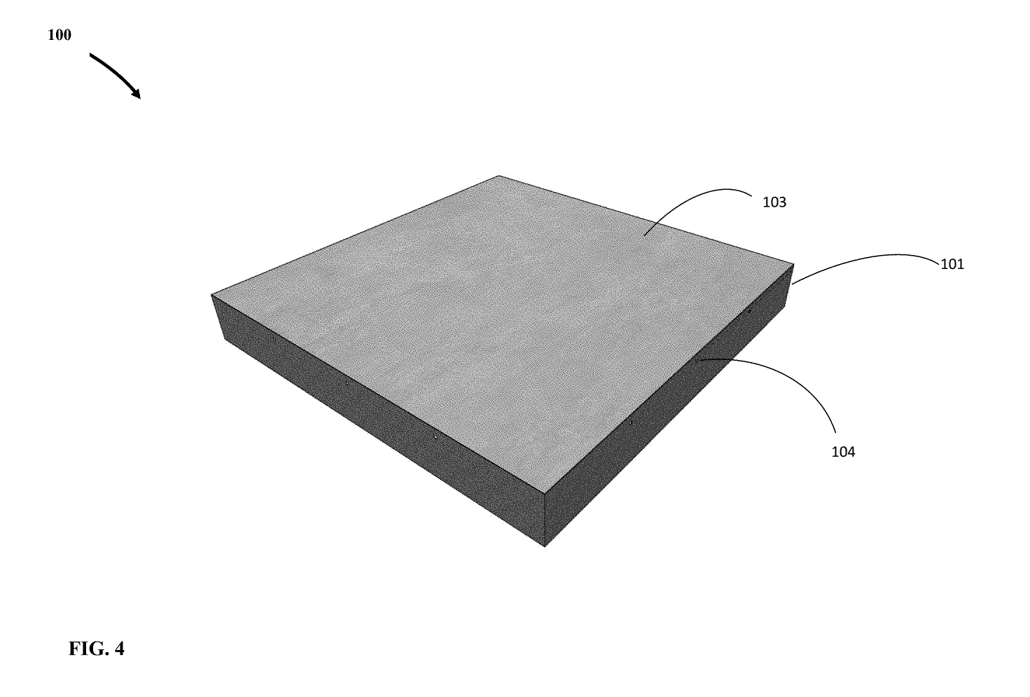

FIG. 4 shows the fully assembled tile 100. Protective layer 103 is placed in position over buoyant layer 102, inside upper compartment of container 101. Protective layer 103 is likely most efficiently realized by pouring wet concrete in the upper compartment filling the space above buoyant layer 102, flush with the top of container 101. While FIG. 4 shows the top surface of protective layer 103 to be flat, it may be cast into any desired shape for both practical and aesthetic purposes. An obvious practical purpose would be surface drainage for which the surface could be cast in the shape of a pyramid with sides sloping at about 1%.

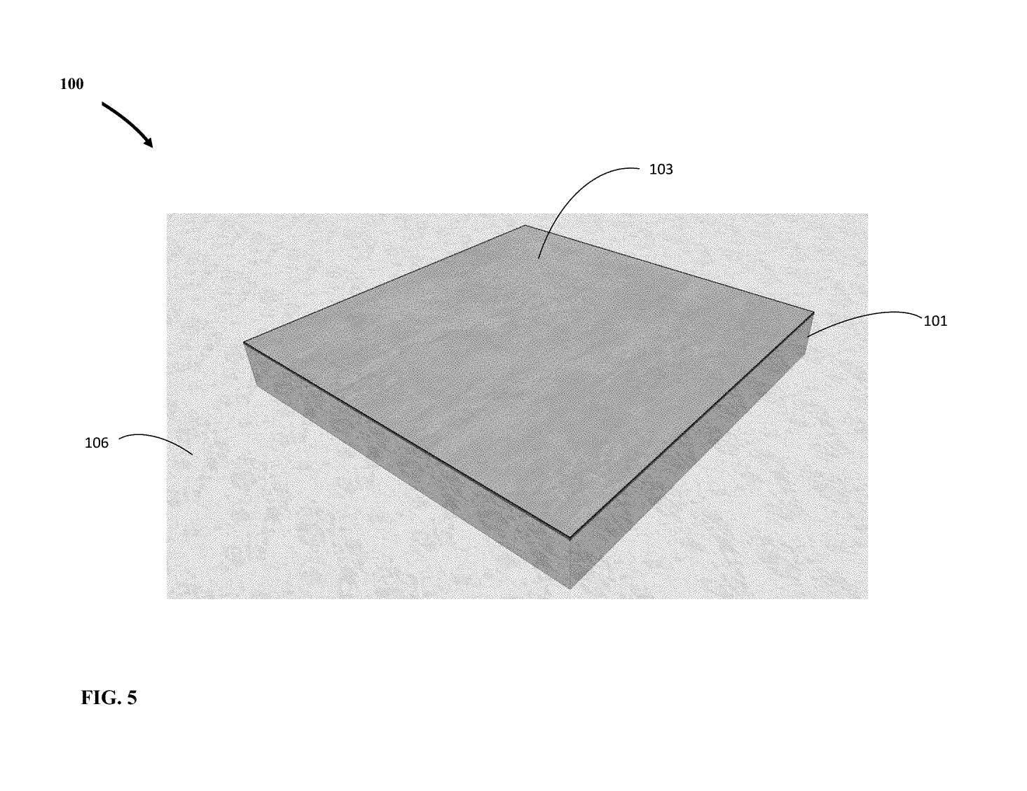

FIG. 5 shows the fully assembled tile 100 floating in water 106. For tile 100 to float in water 106 it must have a unit weight that is less than the unit weight of water 106 to give it a specific gravity of less than one. Table 1 below shows calculations pertaining to the unit weight of the preferred embodiment of the present invention, tile 100.

TABLE 1
Unit weight of the preferred embodiment tile 100

| | | | | | Unit | |
|---|---|---|---|---|---|---|
| De- | Thickness, | Length, | Width, | Volume, | Weight, | Weight, |
| scription | In | In | In | In³ | lbs/ft³ | lbs |
| Walls 101 | 0.04 | 192.00 | 6.75 | 51.84 | 60.5 | 1.8 |
| Partition | 0.04 | 48.00 | 48.00 | 92.16 | 60.5 | 3.2 |
| 105 | | | | | | |
| Buoyant | 0.50 | 48.00 | 48.00 | 1152.00 | 1.6 | 1.0 |
| layer 102 | | | | | | |
| Protective | 0.25 | 48.00 | 48.00 | 576.00 | 145.0 | 48.3 |
| layer 103 | | | | | | |

| | | | |
|---|---|---|---|
| Total | 1872.0 | 50.2 | 54.4 |

Volume of Water Displaced, In³ 1506.8
Depth of Tile below Water, In 6.59
Height of Tile above Water, In 0.16

The preferred embodiment of tile 100 in Table 1 is comprised of a 0.04-inch thick double-compartment container 101 made from high density polyethylene (HDPE) having a 48-inch by 48-inch square surface area, with upper compartment thickness of 0.75 inches containing 0.5-inch thick expanded polystyrene buoyant layer 102, plus 0.25-inch thick layer of concrete protective layer 103, and lower compartment having 6.0-inch tall walls. Accordingly, the sum total weight of the individual components is 54.4 lbs having a total volume of 1872.0 cubic inches (1.08 ft³). Dividing the total weight of the individual components by the total volume results in a tile unit weight of 50.2 lbs/ft³ i.e. less than 62.4 lbs/ft³, which is the minimum unit weight of water 106 (assuming worst case scenario of no dissolved salts). The corresponding specific gravity of tile 100 is 50.2 lbs/ft³ divided by 62.4 lbs/ft³ i.e. 0.80. Therefore, the preferred embodiment of tile 100 floats in water. Based on Archimedes Principal, the weight of water displaced equals the total weight of the tile, which is 54.4 lbs. It follows that the corresponding volume of water displaced equals the submerged volume of tile 100, which is 54.4 lbs divided by 62.4 lbs/ft³ i.e. 0.87 ft³ (1506.8 cubic inches). Accordingly, the corresponding depth of submergence is 6.59 inches leaving 0.16 inches of tile exposed above the water surface.

If it is desired to increase the height of tile above surface of water 106, then the depth of submergence may be reduced by increasing the thickness of buoyant layer 102. Table 2 shows the impact of lowering partition 105 by 0.5 inches and using a 1.0-inch thick buoyant layer 102 while keeping the thickness of protective layer 103 the same.

TABLE 2
Unit Weight of Tile 100 with Increased Thickness of Buoyant Layer 102

| | | | | | Unit | |
|---|---|---|---|---|---|---|
| De- | Thickness, | Length, | Width, | Volume, | Weight, | Weight, |
| scription | In | In | In | In³ | lbs/ft³ | lbs |
| Walls 101 | 0.04 | 192.00 | 6.75 | 51.84 | 60.5 | 1.8 |
| Partition | 0.04 | 48.00 | 48.00 | 92.16 | 60.5 | 3.2 |
| 105 | | | | | | |
| Buoyant | 1.00 | 48.00 | 48.00 | 2304.00 | 1.6 | 2.1 |
| layer 102 | | | | | | |
| Protective | 0.25 | 48.00 | 48.00 | 576.00 | 145.0 | 48.3 |
| layer 103 | | | | | | |

| | | | |
|---|---|---|---|
| Total | 3024.0 | 31.7 | 55.4 |

Volume of Water Displaced, In³ 1534.2
Depth of Tile below Water, In 6.11
Height of Tile above Water, In 0.64

The total volume of material comprising tile 100 increases from 1872.0 to 3024 cubic inches (62%) while the weight of the tile increases by just one pound from 54.4 to 55.4 lbs (2%). Consequently, the unit weight of the tile 100 reduces from 50.2 to 31.7 lbs/ft³ (37%). This results in submerged depth of tile 100 to reduce from 6.59 to 6.11 inches leaving 0.64 inches of tile 100 exposed above water surface.

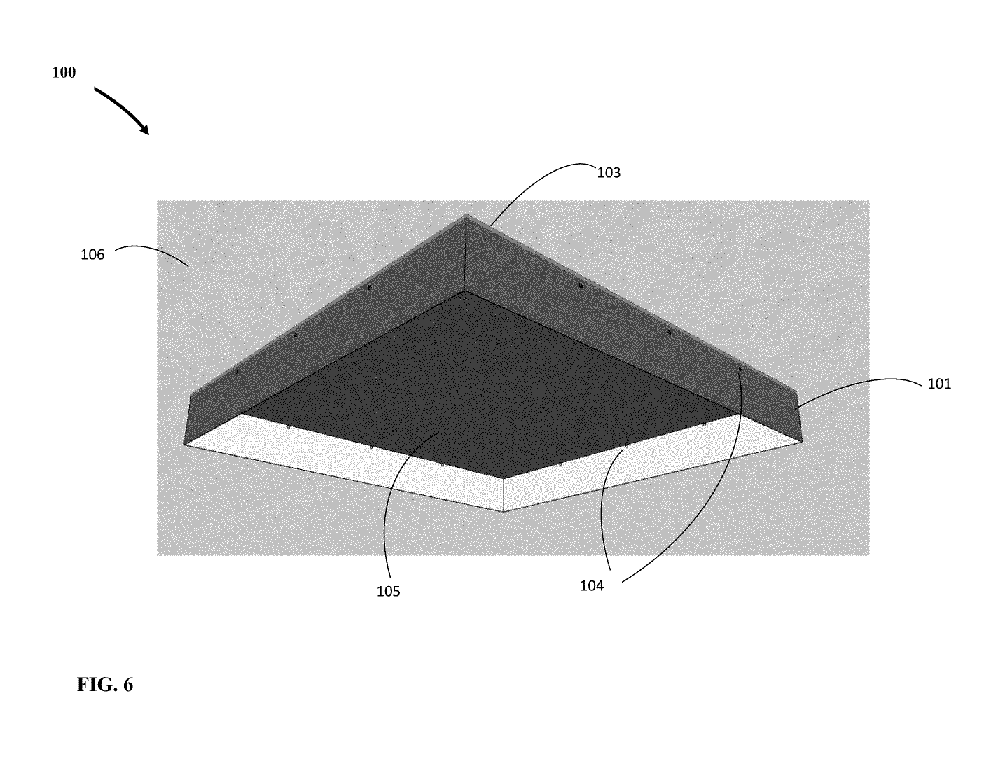

FIG. 6 shows the fully assembled tile 100 from below floating in water. Vent holes 104 below partition 105 have let out all trapped air inside when tile 100 was placed in water 106. Partition 105 is submerged and lower compartment of container 101 is completely filled with water making the effective weight of tile 100 include weight of water contained within. Lateral and vertical movements of tile 100 will also include same movement of water contained within. This significant inertia to tile 100 thus significantly increasing stability while providing tile 100 with resistance against external forces such as the wind and water currents.

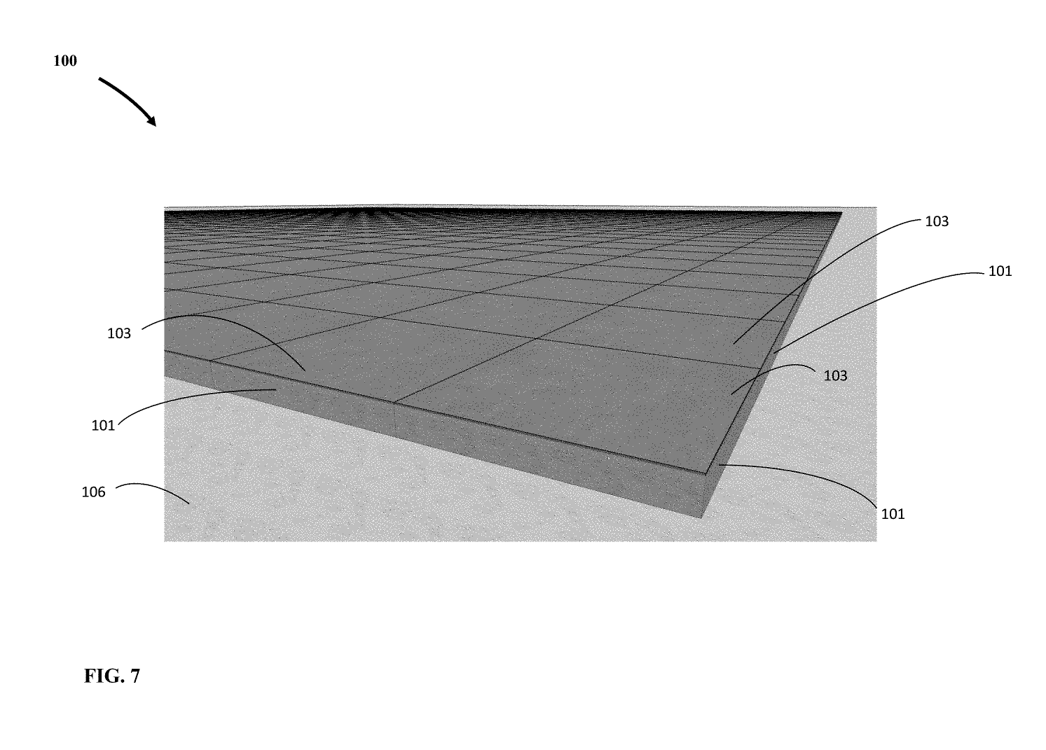

FIG. 7 is a plurality of the tile 100 packed together and floating in water 106. The square geometric shape of tile 100 provides for interchangeability of individual tiles 100 thus eliminating the need for any particular packing order and enabling close packing while avoiding formation of any uncovered areas in-between. The smooth surface of container 101 made from plastic has low sliding friction between the tiles 100 in both vertical and horizontal directions. The independence of tiles 100 from one another eliminates the need for restraints and avoids accumulation of rain water in any particular area and sagging. Rain water falling on individual tiles 100 leaks down through to water 106 as there is no membrane in-between. The large inertia of tiles 106 when packed together provide for a stable cover that requires large forces for lateral movement. The smooth surface area of protective layer 103 and small unsubmerged depth of tile 100 produce very little wind drag, thus requiring only modest means of anchoring along the perimeter of the packed tiles 100 to maintain position at desired location.

The present invention is susceptible to modifications and variations which may be introduced thereto without departing from the inventive concepts and the object of the invention. Geometric forms, dimensions, and materials, other than those disclosed may be used.

While the present invention has been described in connection with what is considered the most practical and preferred embodiments, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A floating tile for shielding open water surfaces from evaporation and external elements, the floating tile comprising:
a container with vertical perimeter wall of uniform height, open at both upper and lower extremities;
a horizontal flat partition of certain thickness inside said container disposed to divide said container into two separate “upper” and “lower” compartments;
at least one hole through said vertical perimeter wall immediately below said partition disposed to establish exchange of air and water between the exterior and the interior of said lower compartment;
a flat buoyant layer fitted inside said upper compartment directly above said partition disposed to provide said tile with sufficient buoyancy to float;
a protective layer fitted inside said upper compartment directly above said buoyant layer disposed to cover and protect said buoyant layer from external elements.

2. A plurality of said floating tiles disposed to shield an open water surface from evaporation and external elements.

3. The floating tile of claim 1 wherein said partition and said flat buoyant layer are one and the same.
